(19) United States
(12) Patent Application Publication
(10) Pub. No.: US 2019/0002046 A1
(43) Pub. Date: Jan. 3, 2019

(54) BOTTOM FRAME OF BICYCLE HANGER

(71) Applicant: JYIN SHENG CO., LTD., Huatan Township (TW)

(72) Inventor: Yu-Lung TSAI, Huatan Township (TW)

(21) Appl. No.: 16/023,825

(22) Filed: Jun. 29, 2018

(30) Foreign Application Priority Data
Jul. 3, 2017 (TW) 106122233

(51) Int. Cl. B62H 3/12; F16M 11/38; A47F 5/04; A47F 7/00

(52) U.S. Cl. CPC B62H 3/12; F16M 11/38; F16M 2200/08; A47F 7/00; A47F 5/04

(57) ABSTRACT

A bottom frame of a bicycle hanger includes a main body having a straight pipe for being sleeved onto a vertical rod, a stopper attached to the bottom end of the straight pipe for preventing the vertical rod from extending out from the bottom end of the straight pipe, a connecting unit attached to the straight pipe, and three legs attached to the connecting unit. At least two of the three legs are pivotably attached to the connecting unit for being unfolded or folded. Each of the at least two pivotable legs has a positioning structure. The positioning structures provide positioning effect to the at least two pivotable legs. The three legs extend from the connecting unit outwardly and downwardly to a position below the bottom end of the straight pipe for being abutted on a ground.

### BACKGROUND OF THE INVENTION

### 1. Field of the Invention

The present invention relates to bicycle hangers and more particularly, to a bottom frame of a bicycle hanger.

### 2. Description of the Related Art

There are usually various bicycles displayed in the bicycle store wherein hangers are usually provided on the wall for hanging up the bicycles. However, the wall has limited area for the disposal of the hangers, so there are also bicycles displayed on the ground in the store for increasing the amount of the bicycles on display. Although the aforesaid manner enables relatively more bicycles to be displayed in the store, much ground area in the store is occupied. The reduction of the unoccupied ground area is liable to bring the feeling of congestion. Besides, if the bicycles on display are arranged abreast, it is difficult to move the bicycles when the bicycles should be taken or moved. Furthermore, when installation or maintenance of the related accessories or the components of the bicycle should be performed, the bicycle disposed on the ground is inconvenient for the operation.

China Patent No. CN 203041526 U disclosed a movable parking frame including a main frame body, top layer hooks, middle hooks, and a multiple-pin bracket. The top layer hooks are disposed at the top end of the main frame body. The middle hooks are disposed at the middle part of the main frame body. The multiple-pin bracket is disposed right under the main frame body and fixedly sleeved onto the main frame body for supporting the whole main frame body and the load.

In addition, Taiwan Patent No. I294379 disclosed a bicycle hanger having the maintenance function, which includes a bottom frame, an external pipe, an internal pipe, a connecting mechanism, and a hanging mechanism. Referring to FIG. 2 of the patent, the bottom frame may be embodied as a foldable tripod.

In the thought of the applicant of the present invention on the China Patent No. CN 203041526 U, the movable parking frame of the patent can hang up the bicycle to enhance the applicability of space and the convenience of the movement of the bicycle. However, the multiple-pin bracket is spread from the bottom of the main frame body. Therefore, in the process that the movable parking frame of the patent is moved to change its position, the spread multiple-pin bracket may cause the mover to unintentionally kick the multiple-pin bracket and thereby stumbled during moving the movable parking frame so as to get into danger. Besides, when the movable parking frame of the patent is in storage, it needs much storage space because the multiple-pin bracket is unchangeable in the form thereof. For saving space, the multiple-pin bracket in the patent should be disassembled, but that brings another problem of consuming time for assembly.

On the other hand, in the thought of the applicant of the present invention on the Taiwan Patent No. I294379, the bottom frame in the patent can be folded through a first fastening device, thereby solving the problem of inconvenience movement of the China Patent No. CN 203041526 U. However, the bottom frame in the Taiwan Patent No. I294379 is folded in a way that the first fastening device is displaced vertically. Therefore, when the first fastening device is displaced upwardly to make the bottom frame in the patent folded, each leg of the bottom frame is moved toward the external pipe and then has an included angle nearly 90 degrees with the ground. In this way, the folding of the bicycle hanger of the patent causes increase of the length of the whole hanger. Therefore, if the hanger is used in a way that the hanger is abutted on the ceiling and the ground, or the whole hanger in the state that the legs are located by the external pipe is longer than the perpendicular distance between the ceiling and the ground, the hanger should be inclined before getting into storage, resulting in inconvenience in storage.

### SUMMARY OF THE INVENTION

It is a primary objective of the present invention to provide a bottom frame of a bicycle hanger, the legs of which can be folded by pivoting and such folding will not change the length of the whole bicycle hanger, so that the bottom frame benefits the storage and movement of the bicycle hanger, thereby convenient in usage.

To attain the above objective, the present invention provides a bottom frame of a bicycle hanger, which includes a main body having a straight pipe, a stopper, a connecting unit and three legs. The straight pipe is adapted to be sleeved onto a vertical rod. The stopper is attached to the bottom end of the straight pipe for preventing the vertical rod from extending out from the bottom end of the straight pipe. The connecting unit is attached to the straight pipe. The three legs are attached to the connecting unit, and the three legs includes at least two pivotable legs pivotably attached to the connecting unit. Each of the at least two pivotable legs has a positioning structure. The positioning structures provide positioning effect to the at least two pivotable legs. The three legs extend from the connecting unit outwardly and downwardly to a position below the bottom end of the straight pipe for being abutted on a ground.

Through the technical feature that at least two of the three legs are pivotably attached to the connecting unit, at least two legs in the present invention can be folded by pivoting and such folding will not cause the problem as mentioned in the description of the related art that the length of the whole bicycle hanger will be changed, so that the bottom frame benefits the storage and movement of the bicycle hanger, thereby relatively more convenient in usage.

### BRIEF DESCRIPTION OF THE DRAWINGS

FIG. 1 is an assembled perspective view of an embodiment of the present invention.

FIG. 2 is an exploded perspective view of the embodiment of the present invention.

FIG. 3 is a top view of the embodiment of the present invention, showing three legs are disposed in an unfolded state.

FIG. 4 is another top view of the embodiment of the present invention, showing the three legs are disposed in a folded state.

FIG. 5 is a sectional view taken along the line 5-5 in FIG. 3, showing the condition that an elastic member is released.

FIG. 6 is a sectional view similar to FIG. 5 but showing the condition that the elastic member is compressed.

FIG. 7 is a schematic view showing a usage condition of the embodiment of the present invention.

FIG. 8 is a schematic view showing another usage condition of the embodiment of the present invention accompanied with a vertical rod and an internal rod.

### DETAILED DESCRIPTION OF THE INVENTION

For the detailed description of the technical features of the present invention, an embodiment is given herein below and illustrated by the accompanying drawings.

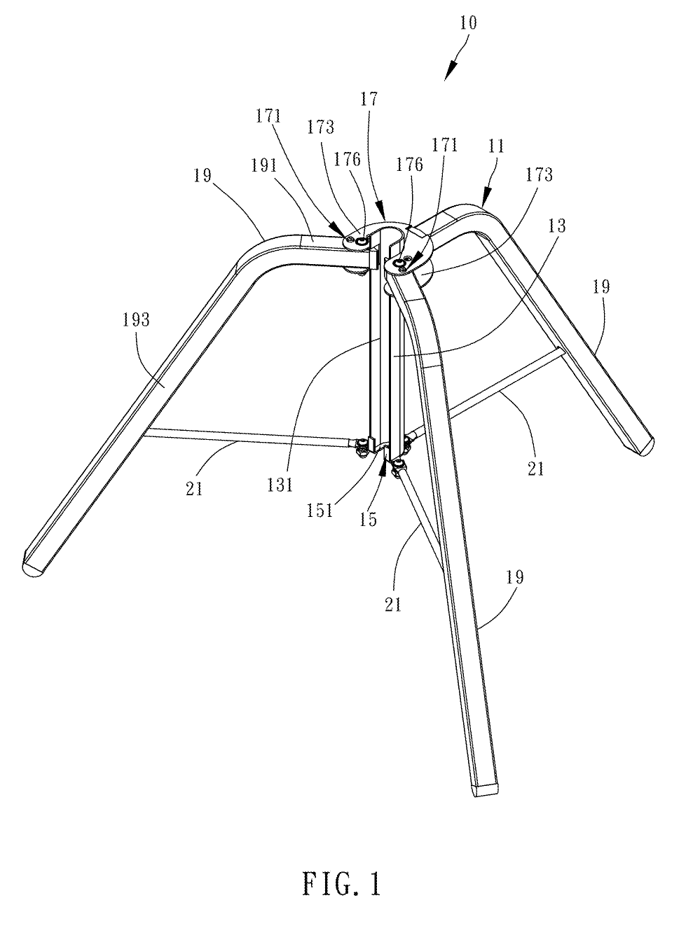

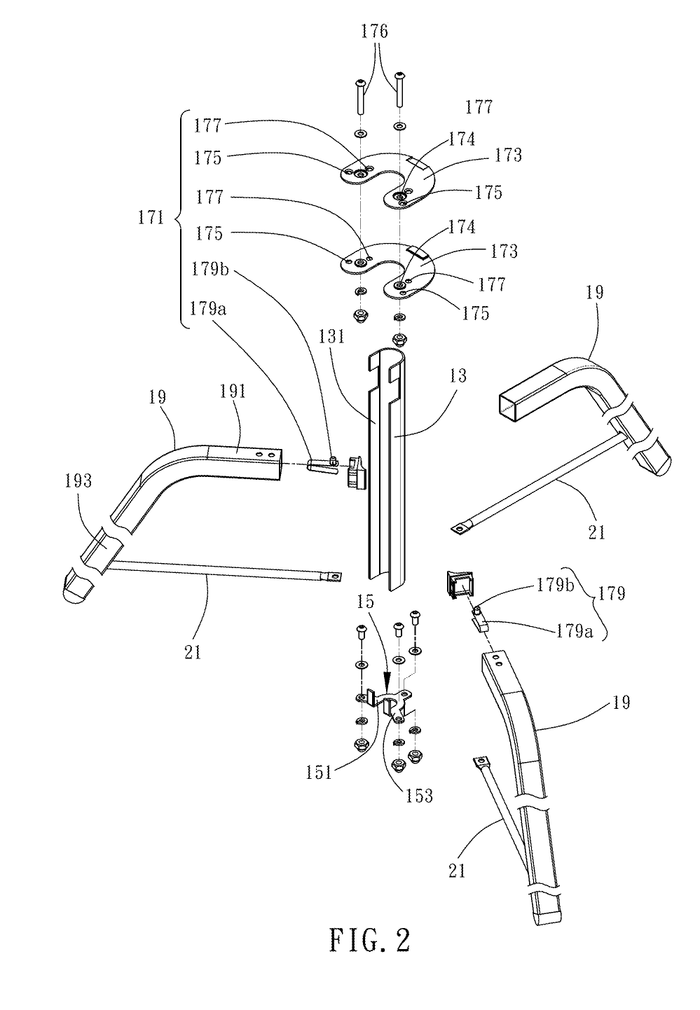

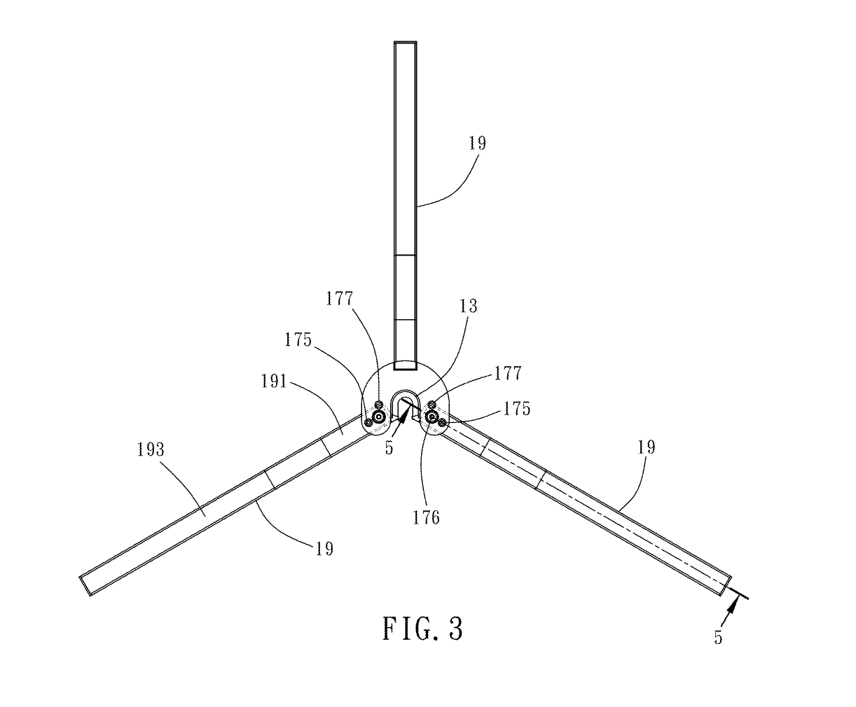

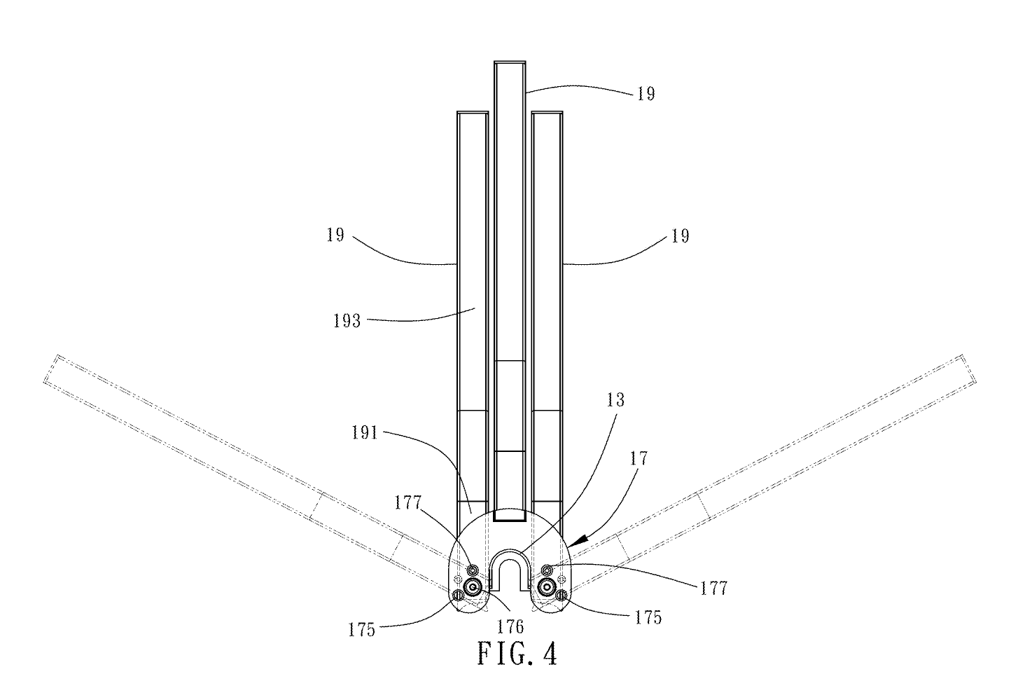

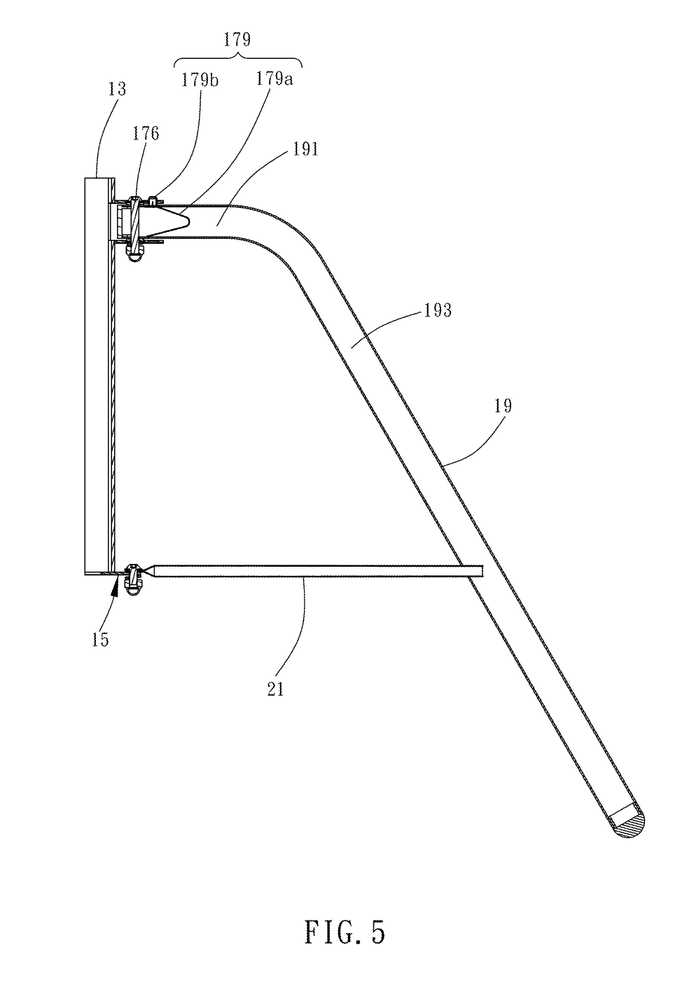

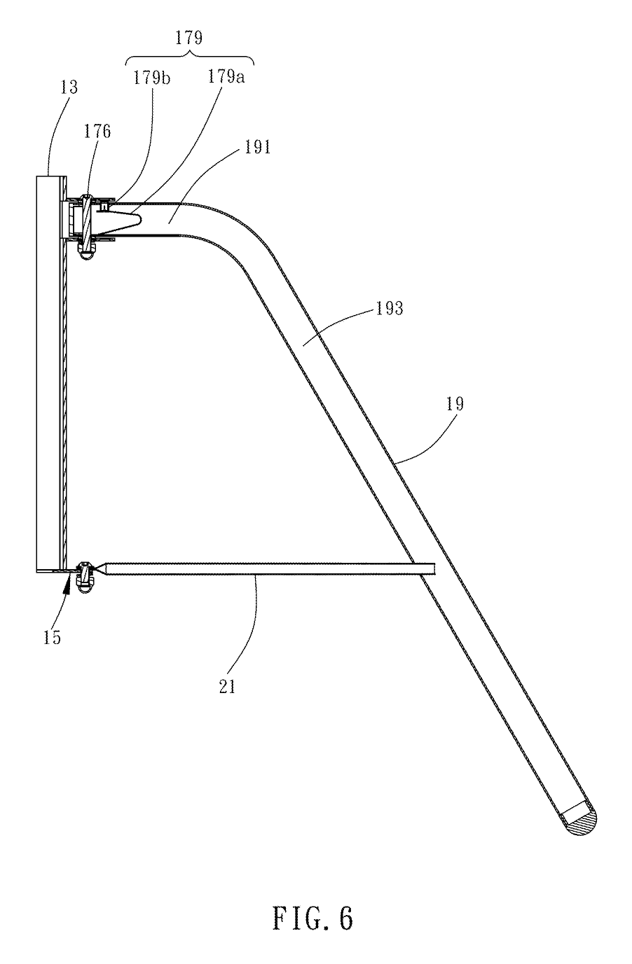

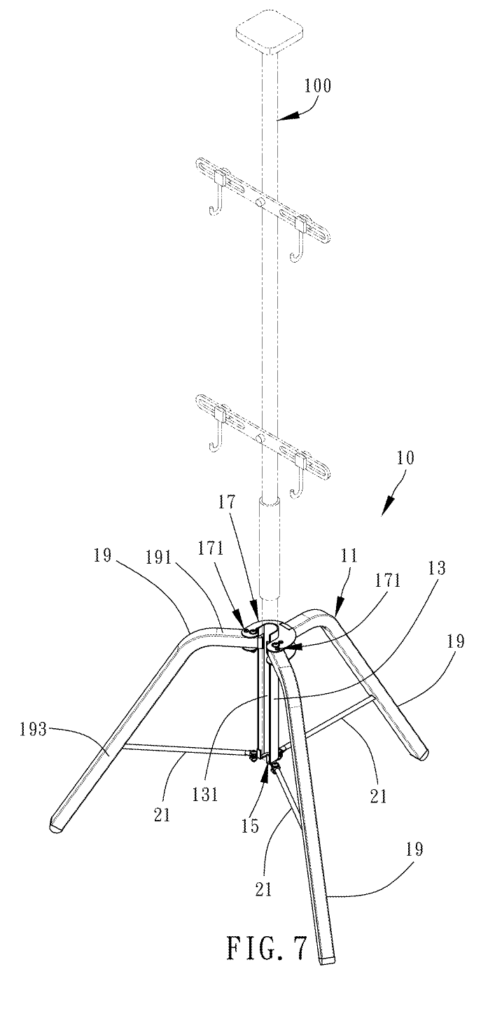

Referring to FIGS. 1-7, a bottom frame 10 of a bicycle hanger according to an embodiment of the present invention primarily includes a main body 11.

The main body 11 has a straight pipe 13, a stopper 15, a connecting unit 17, and three legs 19. The straight pipe 13 is adapted to be sleeved onto a vertical rod 100. The stopper 15 is attached to the bottom end of the straight pipe 13 for preventing the vertical rod 100 from extending out from the bottom end of the straight pipe 13. The connecting unit 17 is attached to the straight pipe 13. The three legs 19 are attached to the connecting unit 17, and at least two of the three legs 19 are pivotably attached to the connecting unit 17. In this embodiment, the amount of the at least two pivotable legs 19 is two. Each of the two pivotable legs 19 has a positioning structure 171. The positioning structures 171 provide positioning effect to the two pivotable legs 19. The three legs 19 extend from the connecting unit 17 outwardly and downwardly to a position below the bottom end of the straight pipe 13 for being abutted on a ground.

In this embodiment, the connecting unit 17 has two fixed plates 173, a plurality of pivot holes 174, and at least two pivots 176. The two fixed plates 173 are U-shaped. The plate surfaces of the two fixed plates 173 are arranged horizontally. The two fixed plates 173 are disposed to face each other vertically. An end of each of the three legs 19 is attached to the two fixed plates 173 and located between the two fixed plates 173. One of the three legs 19 is fixed to the two fixed plates 173, and the other two pivotable legs 19 are pivotably attached to the two fixed plates 173. The plurality of pivot holes 174 are provided on the two fixed plates 173, and the plurality of pivot holes 174 of one of the two fixed plates 173 are located opposite to the plurality of pivot holes 174 of the other fixed plate 173 respectively. The amount of the at least two pivots 176 is two. The two pivots 176 are inserted through the associated plurality of pivot holes 174 and the two pivotable legs 19. As a result, the two pivotable legs 19 can be folded by pivoting toward the fixed leg 19. In other embodiments, the shape of the two fixed plates 173 can be modified according to the modification of the amount of the legs 19 in a way that the two fixed plates 173 are forced evenly. Therefore, the shape of the two fixed plates 173 is modifiable and unlimited to that provided in this embodiment. Besides, the amount of the three legs 19 is the fewest for the bottom frame of the present invention to be disposed on the ground stably, so the embodiments provided with more than three legs should be all included in the patent protective scope of the present invention. Besides, in other embodiments, the three legs 19 can be all pivotable. In the process that the three legs 19 are folded, anyone of the legs 19 can serve as the base, toward which the other two legs 19 are moved. The aforesaid variation is determined by only the modification of the manner of the three legs 19 being connected with the connecting unit 17 and achieves the same effect with the present invention. Therefore, the manner of the three legs 19 being connected with the connecting unit 17 is unlimited to that provided in this embodiment.

In this embodiment, each of the legs 19 has a first section 191 extending from the connecting unit 17 outwardly and transversely and a second section 193 extending from the first section 191 downwardly and away from the straight pipe 13, and the bottom end of the second section 193 is adapted to be abutted on the ground. In other embodiments, each of the legs 19 may directly extend from the connecting unit 17 downwardly and away from the straight pipe 13 to be abutted on the ground. Therefore, the embodied form of the three legs 19 is unlimited to that provided in this embodiment.

In this embodiment, the straight pipe 13 has an opening 131 penetrating axially. The width of the opening 131 is equal to the width of the vertical rod 100. As a result, during the installation of the present invention, the straight pipe 13 is directly sleeved onto the vertical rod 100 through the opening 131. The advantage is that because the straight pipe 13 has the opening 131, the orientation of the vertical rod 100 doesn't need to be changed during the installation, and the installation can be accomplished by directly sleeving the straight pipe 13 onto the vertical rod 100. The opening 131 and the technical feature that the width of the opening 131 is equal to the width of the vertical rod 100 can effectively prevent the vertical rod 100 from escaping from the straight pipe 13. Therefore, the aforesaid structure makes the installation of the present invention relatively more convenient. In other embodiments, the width of the opening 131 can be set to be smaller than the width of the vertical rod 100 (not shown), which is also effective in preventing the vertical rod 100 from escaping from the straight pipe 13. Therefore, the width of the opening 131 and the width of the vertical rod 100 are unlimited to that provided in this embodiment. Besides, the installation of the present invention can be performed in a way that the top end of the straight pipe 13 is aimed at the bottom end of the vertical rod 100 and then the straight pipe 13 is directly sleeved onto the vertical rod 100. In such condition, the opening 131 is unnecessary for the combination of the straight pipe 13 and the vertical rod 100. It can be understood from the above description that the opening 131 is not the indispensable element of the present invention. In the condition of no such opening 131, the effect of the present invention is also achievable.

In this embodiment, each of the positioning structures 171 is composed of two first fixing holes 175 located at the two fixed plates 173 respectively and located opposite to each other, two second fixing holes 177 located at the two fixed plates 173 respectively and located opposite to each other, and a positioning unit 179 composed of an elastic member 179a and a pressed head 179b. The elastic member 179a is located in the pivotable leg 19 and partially abutted on a bottom portion of the pivotable leg 19. When the two pivotable legs 19 are disposed in an unfolded state, the pressed heads 179b are partially located in the first fixing holes 175 and partially exposed out of the first fixing holes 175. When the two pivotable legs 19 are disposed in a folded state, the pressed heads 179b are partially located in the second fixing holes 177 and partially exposed out of the second fixing holes 177. When the pressed heads 179b are partially exposed out of the first fixing holes 175 or the second fixing holes 177, a predetermined resistance is caused to the two pivotable legs 19 so that the two pivotable legs 19 are positioned. However, in other embodiments, when the two pivotable legs 19 are disposed in the folded state, the two pivotable legs 19 in the folded state can be positioned in a way that the pressed heads 179b are directly abutted on a top portion of the pivotable legs 19 to provide sufficient friction to disable the pivotable legs 19 to pivot. Therefore, the condition of the positioning structures 171 positioning the two pivotable legs 19 in the folded state is unlimited to that provided in this embodiment.

In this embodiment, the stopper 15 has a U-shaped bottom plate 151 abutted on the bottom end of the straight pipe 13, and the width of the opening defined by the bottom plate 151 is smaller than the width of the vertical rod 100. As a result, the vertical rod 100 is prevented from extending out from the bottom end of the straight pipe 13. In other embodiments, the stopper 15 and the straight pipe 13 can be formed integrally. The bottom plate 151 of the stopper 15 may be shaped annularly to form an enclosed opening. In the condition that the width of the enclosed opening is smaller than the width of the vertical rod 100, the effect of the present invention is also achievable. Therefore, the shape of the stopper 15 and the manner of the stopper 15 being connected with the straight pipe 13 are unlimited to that provided in this embodiment.

In this embodiment, the bottom frame further has three connecting rods 21. The connecting rods 21 are connected with the legs 19 respectively through an end of each of the connecting rods 21, and another end of each of the connecting rods 21 is pivotably connected with the stopper 15. The stopper 15 has three protrusions 153. The connecting rods 21 are pivotably connected with the protrusions 153 respectively through the aforesaid another end of each of the connecting rods 21. Because the three legs 19 are connected with the connecting unit 17 through only an end of each of the three legs 19, when the three legs 19 are struck by an improper external force, the connecting unit 17 is liable to be damaged. Besides, each of the two pivotable legs 19 pivots through only an end thereof being connected with the connecting unit 17, the pivoting angle of which is liable to have deviation to cause the connecting unit 17 damaged. Through the structural feature that the three connecting rods 21 are attached to the three legs 19 and the stopper 15, when the three legs 19 are struck by the improper external force, the impact against the connecting unit 17 is effectively shared out. Besides, the structural feature that the three connecting rods 21 are attached to the three legs 19 and the stopper 15 can also makes the pivoting path of the two pivotable legs 19 relatively steadier. However, if no improper external force exists in the operating environment or the pivoting manner will not cause deviation, the bottom frame can be provided without the three connecting rods 21 and the three protrusions 153. Therefore, the three connecting rods 21 and the three protrusions 153 are not the indispensable elements to achieve the effect of the present invention.

The above description illustrates the structural configuration of the embodiment, the following description will illustrate the usage condition of the first embodiment.

When the present invention is in use, referring to FIGS. 1-7, the three legs 19 are disposed in the unfolded state, the pressed heads 179b are partially located in the first fixing holes 175 and partially exposed out of the first fixing holes 175, so that the three legs 19 are positioned. When the present invention is to be folded in the finish of the usage, the pressed heads 179b located in the first fixing holes 175 are pressed by fingers and at the same time the two pivotable legs 19 are pulled toward the fixed leg 19. Because the pressed heads 179b are pressed by the fingers, the elastic members 179a are compressed and the pressed heads 179b are moved into the first fixing holes 175. At this time, the predetermined resistance is smaller than the force pulling the two pivotable legs 19, so that the two pivotable legs 19 can pivot toward the fixed leg 19. When the pressed heads 179b moved from the first fixing holes 175 are located at the second fixing holes 177, the pressed heads 179b are pushed by the resilient force of the elastic members 179a to be partially located in the second fixing holes 177 and partially exposed out of the second fixing holes 177, so that the two pivotable legs 19 in the folded state are positioned.

As a result, through the technical feature that the two pivotable legs 19 are pivotably attached to the connecting unit 17, the two pivotable legs 19 of the present invention can be folded by pivoting and such folding will not cause the problem as mentioned in the description of the related art that the length of the whole bicycle hanger will be changed, so that the bottom frame benefits the storage and movement of the bicycle hanger, thereby relatively more convenient in usage.

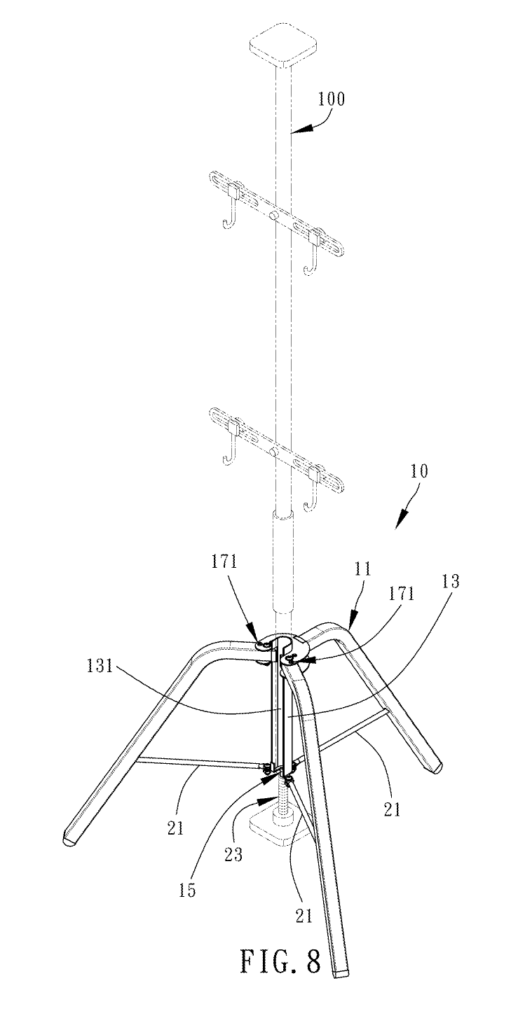

Furthermore, referring to FIGS. 1-6 and FIG. 8, the bottom frame 10 of the bicycle hanger is used accompanying with the vertical rod 100, and the vertical rod 100 can be used accompanying with an internal rod 23. The width of the internal rod 23 is smaller than the width of the opening defined by the bottom plate 151. An end of the internal rod 23 is screwed into an end of the vertical rod 100. Another end of the internal rod 23 is inserted though the opening defined by the bottom plate 151 and located below the straight pipe 13. When the internal rod 23 is screwed out from the vertical rod 100 for a predetermined length, the aforesaid another end of the internal rod 23 will exceed the surfaces of the three legs 19 for contacting the ground, and the aforesaid another end of the internal rod 23 can be abutted on the ground instead of the legs. In this way, if the combination of the bottom frame 10 of the bicycle hanger and the vertical rod 100 should be abutted on a ceiling and the ground but the total length is insufficient for that, the aforesaid internal rod 23 can be used to increase the total length of the whole structure, thereby solving the problem that the combination of the bottom frame 10 of the bicycle hanger and the vertical rod 100 is insufficient in length.

What is claimed is:

1. A bottom frame of a bicycle hanger, the bottom frame comprising:
a main body having a straight pipe, a stopper, a connecting unit and three legs, the straight pipe being adapted to be sleeved onto a vertical rod, the stopper being attached to a bottom end of the straight pipe for preventing the vertical rod from extending out from the bottom end of the straight pipe, the connecting unit being attached to the straight pipe, the three legs being attached to the connecting unit, the three legs comprising at least two pivotable legs pivotably attached to the connecting unit, each of the at least two pivotable legs having a positioning structure, the positioning structures providing positioning effect to the at least two pivotable legs, the three legs extending from the connecting unit outwardly and downwardly to a position below the bottom end of the straight pipe for being abutted on a ground.

2. The bottom frame as claimed in claim 1, wherein the connecting unit has two fixed plates, a plurality of pivot holes and at least two pivots; plate surfaces of the two fixed plates are arranged horizontally; the two fixed plates are disposed to face each other vertically; an end of each of the three legs is attached to the two fixed plates and located between the two fixed plates; one of the three legs is fixed to the two fixed plates, and the other legs, which are said at least two pivotable legs, are pivotably attached to the two fixed plates; the plurality of pivot holes are provided on the two fixed plates, and the plurality of pivot holes of one of the two fixed plates are located opposite to the plurality of pivot holes of the other fixed plate respectively; the at least two pivots are inserted through the plurality of pivot holes associated with the pivots and the at least two pivotable legs.

3. The bottom frame as claimed in claim 2, wherein the two fixed plates are U-shaped.

4. The bottom frame as claimed in claim 2, wherein each of the positioning structures is composed of two first fixing holes located at the two fixed plates respectively and located opposite to each other, two second fixing holes located at the two fixed plates respectively and located opposite to each other, and a positioning unit composed of an elastic member and a pressed head; the elastic member is located in the pivotable leg and partially abutted on a bottom portion of the pivotable leg; when the at least two pivotable legs are disposed in an unfolded state, the pressed heads are partially located in the first fixing holes and partially exposed out of the first fixing holes; when the at least two pivotable legs are disposed in a folded state, the pressed heads are partially located in the second fixing holes and partially exposed out of the second fixing holes.

5. The bottom frame as claimed in claim 1, wherein the straight pipe has an opening penetrating axially; a width of the opening is equal to or smaller than a width of the vertical rod.

6. The bottom frame as claimed in claim 1, wherein each of the legs has a first section extending from the connecting unit outwardly and transversely and a second section extending from the first section downwardly and away from the straight pipe, and a bottom end of the second section is adapted to be abutted on the ground.

7. The bottom frame as claimed in claim 1, wherein the bottom frame further has three connecting rods; the connecting rods are connected with the legs respectively through an end of each of the connecting rods; another end of each of the connecting rods is pivotably connected with the stopper.

8. The bottom frame as claimed in claim 7, wherein the stopper has three protrusions; the connecting rods are pivotably connected with the protrusions respectively through said another end of each of the connecting rods.

9. The bottom frame as claimed in claim 1, wherein the stopper has a bottom plate which is U-shaped and abutted on the bottom end of the straight pipe; a width of an opening defined by the bottom plate is smaller than a width of the vertical rod.
